(19) United States
(12) Patent Application Publication
(10) Pub. No.: US 2013/0032022 A1
(43) Pub. Date: Feb. 7, 2013

(54) Acoustic Personal Monitor

(71) Applicant: David Paul Chamberlain, Chula Vista, CA (US)

(72) Inventor: David Paul Chamberlain, Chula Vista, CA (US)

(21) Appl. No.: 13/107,639

(22) Filed: Aug. 2, 2011

(51) Int. Cl. G10D 9/00

(52) U.S. Cl. 84/453

(57) ABSTRACT

A musicians hearing device by which a musician may easily hear in a more clear and obvious way what is coming out of their horn or musical instrument. The acoustic personal monitor samples the tones being created inside the instrument and channels the frequency out of the instrument, extending to the musician and through a sealed ear bud into their ear or ears.

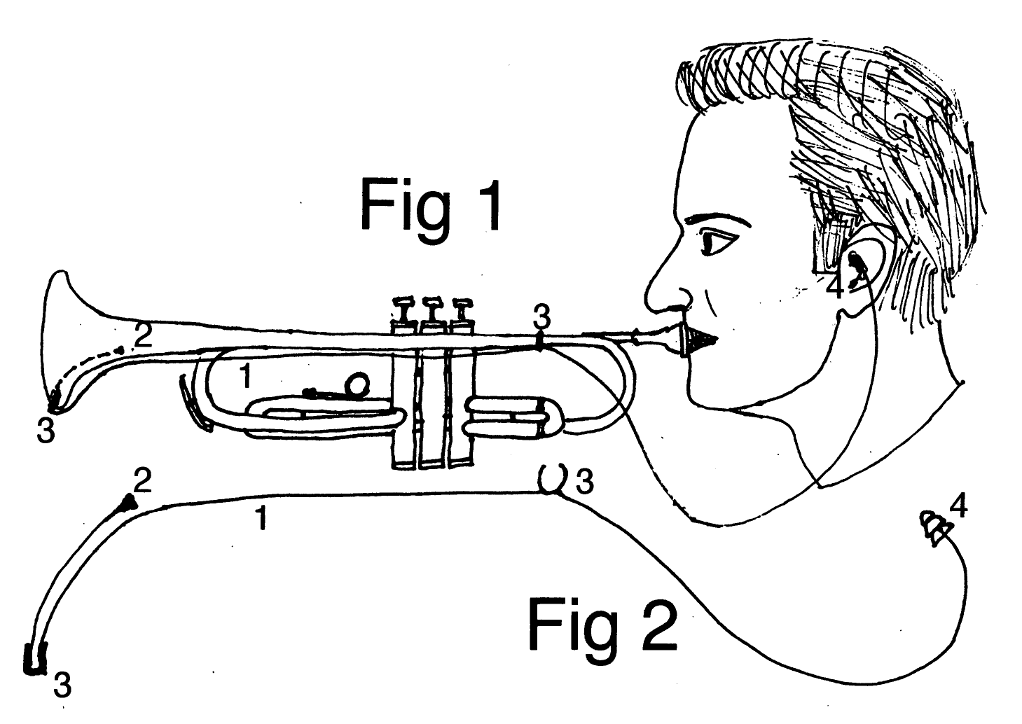

### FIELD OF THE INVENTION

The present invention relates to a system for monitoring sounds, and more specifically to a sound monitoring system for musicians that transfers sound from the instrument to the ear, allowing the musician to sense the intensity and duration of those sounds by touch.

### BACKGROUND OF THE INVENTION

Performance music commonly uses electronic amplification, whether out of necessity given the electronic nature of the musical instruments themselves, or in response to the high sound volumes demanded by today's listeners. Unfortunately, under circumstances of high amplification, the volume of performance sound can interfere with and overwhelm the ability of the musicians to monitor their performances.

For example, most live band performances include a drummer. The drummer is traditionally positioned behind the other players, thereby allowing the drummer to hear a blend, or “mix” of the total performance sound in order to maintain consistency. However, under high sound volume conditions, the drummer usually requires a stage monitoring speaker independent from speakers designed to project sound to the audience, to provide a controlled sound reference for himself and for the other performers. The stage monitor speakers generally need to be large in order to reproduce the desired “mix” at very high sound pressure levels. Most often, the bass drum and bass guitar are the loudest components of this “mix”, and the stage monitor speakers must reproduce the full sound of the instruments in order to assist the drummer to work along with the other members of the band.

The relatively high amplification required by the stage monitoring speaker creates two serious problems. First, longer sound waves generated by the low frequency component of the stage monitoring speakers permeate, or “bleed”, into microphones that are transmitting the performance sound to the listeners. Unwanted mixing of monitoring sound and performance sounds can occur at different times, due to the varying distances between the microphones and the stage monitor speakers.

As a result of the unwanted transmission of low frequency sound waves from the stage monitor speakers into the microphones, the phase coherence of any given sound wave is unpredictably distorted. This distortion occurs because of the additive effect of combining slightly different phases of sound caused by the various distances between the microphones and the stage monitor. This interaction between monitoring and performance sound can compromise both the overall performance mix and the monitor mix.

Bleeding of low frequency sound waves from the stage monitor into the microphones also reduces control over the performance sound mix. The sheer sound pressure level from the stage monitor, in particular the lowest frequency sound waves which produce most of the energy, degrade the quality of sound produced by the individual instruments. For example, as an overhead microphone is brought up in volume to reproduce the cymbals, it will also capture sound of the entire mix of instruments generated by the stage monitor. When this interaction occurs, the individual sound quality of the respective instruments is lost, and the quality of the overall mix declines.

A second problem associated with conventional sound monitoring relates to the range of sound frequencies associated with the various instruments. For example, the low sound frequencies of the bass drum and bass guitar referenced by the drummer are in the frequency range of thirty-to-eighty cycles. At thirty cycles, the corresponding sound wave is almost forty feet long. As the drummer is typically about three feet from the stage monitor, the forty foot wave cannot properly develop to allow the drummer to hear it well.

Unfortunately, many musicians increase the volume of the stage monitor in order to compensate for this disparity between sound wavelength and distance from the stage monitor. Resulting elevated sound volume causes excessive consumption of power and abuse to the speakers, and often prompts the surrounding band members to play louder. The compounded increase in sound volume can damage the drummer's hearing. Hearing loss is today a common and serious problem among musicians.

Accordingly, what is needed in the art is an in-ear monitor that combines the performance associated with multiple drivers and multiple delivery tubes with the convenience and cost benefits associated with in-ear monitors. The present invention provides such a monitor.

This simple devise allows the performing musician the ability to hear their own instrument above all the loud noise of the ensemble or band. It's straightforward and foolproof.

### SUMMARY OF THE INVENTION

A tube extending from the source of the sound, on a musical instrument, to the musicians ear or ears.

I've invented the means by which a musician may easily hear in a more clear and obvious way what is coming out of their horn or musical instrument. The acoustic personal monitor samples the tones being created inside the instrument and channels the frequency out of the instrument, extending to the musician and through a sealed ear bud into their ear or ears.

### BRIEF DESCRIPTION OF THE DRAWINGS

Other objects, features and advantages of the present invention will become apparent from the detailed description of the invention which follows, when considered in light of the accompanying drawings which:

### DETAILED DESCRIPTION OF THE PREFERRED EMBODIMENTS

[symbol]

1. An acoustic personal monitor comprising:
A hollow tube with a conical flared opening inside the musical instrument, emerges and is attached to the outside of the instrument and is secured to the musician's ear canals.

2. An acoustic personal monitor of claim 1, wherein the wind carrying the musical tone created in the musical instrument is carried through the tube and released in the ears of the musician.
